(19) United States
(12) Patent Application Publication
(10) Pub. No.: US 2022/0305760 A1
(43) Pub. Date: Sep. 29, 2022

(54) SMALL RADII COMPLEX SHAPE LAMINATED GLAZING

(71) Applicant: AGP America S.A., Ciudad de Panama (PA)

(72) Inventors: Mario Arturo MANNHEIM ASTETE, Lima (PE); Natalia Andrea RUEDA GUERRERO, Lima (PE); Andres Fernando SARMIENTO SANTOS, Lima (PE); Jean Marie LE NY, Gemmenich (BE); Mauricio Fernando CORNEJO POL, Lima (PE)

(21) Appl. No.: 17/619,443

(22) PCT Filed: Jun. 17, 2020
(86) PCT No.: PCT/IB2020/055671

§ 371 Date: Dec. 15, 2021

Related U.S. Application Data
(60) Provisional application No. 62/862,647, filed on Jun. 17, 2019.

(51) Int. Cl. B32B 17/10; B32B 3/26

(52) U.S. Cl. CPC B32B 17/10568; B32B 17/10293; B32B 17/10036; B32B 17/10908; B32B 3/263; B32B 2605/006; B32B 2307/412; B32B 2307/416

(57) ABSTRACT

It is now possible to economically produce, in series production, automotive glazing that has complex small radii feature lines (30). Such feature lines (30) are desirable as they can improve the stiffness of the glazing as well as contribute to the overall aesthetic and differentiation of the vehicle, allowing body lines to blend into and continue in the glazing. However, traditional automotive laminating methods do not lend themselves well to this type of product. Typically, the offset between the mating surfaces of the laminate must be very uniform. Such uniformity is difficult to achieve when producing small radii features. Rather than bending multiple layers with small radii feature lines that can be nested and subsequently laminated using standard plastic automotive interlayers, the invention makes use of a two part method for laminating, a dry lamination process and a wet lamination process, which requires only that the feature lines (30) be present in the outer glass layer (201).

### FIELD OF THE INVENTION

This invention is related to the field of laminated automotive glazing.

### BACKGROUND OF THE INVENTION

For several decades, it has been possible to produce tempered monolithic automotive glass glazing, with small radii bends, though the use of resistive localized heating. In the typical process, the whole flat glass sheet is heated to the temperature range where the glass can be bent to shape without introducing optical distortion and then additional heat is added by means of a resistive heating element in close proximity or in contact with the surface in the areas where the small radii bend is desired. Due to the limitations on the shape and mounting means of the resistive heating employed, the bends generally need to be straight line bends. Due to the higher cost and limitations of the process, very few vehicles have been equipped with this type of glazing.

The small radii bending process described produces what are known as feature lines. Feature lines are defined as a specific type of sharply curved portion of a vehicle glazing. The sharply curved portion of the glass may extend from one edge and progressively disappear along the surface of the glass. The sharply curved portion is obtained by locally heating, by means of laser processing, the portion of the glass to a temperature sufficiently high enough to allow said portion of glass to bend. In preferred embodiments, the sharply curved portion comprises a first bent portion described by a first radius and a second bent portion described by a second radius, wherein the point where the radiuses of the first and second bent portions change their orientation generate an inflection point. The radius of curvature of the first and second bent portions is of less than 100 mm.

Currently, a number of developments have made it possible to economically produce small radii bends in glass through the use of the use of LASERs and other non-contact heating means. These methods have in common the use of non-contact localized heating to further soften the glass in the desired area, facilitating the production of small radii bends in the glass, similar in some cases, to the ribs pressed into metal body panels to stiffen the body. Due to the optical steering of the beam, the localized heating can be precisely applied to any portion of the glass and in any pattern or shape making it practical to produce complex shapes following curves and with multiple radii.

In some processes, the flat glass may be heated and pre-bent to the partial final shape with the localized heating and bending done is a separate step. Alternately, in some forming methods, the heated glass is bent in one step. Typically, at least one full surface mold is required. The glass may be forced to conform to the shape of the mold by applying vacuum, by mechanical means (an opposing press) or by a combination of the two.

The glazing produced by the resistive heating method is typically tempered monolithic. For all glazing positions other than the windshield, tempered glass may be used. However, it is often desirable to have a laminated glazing rather than a tempered glazing even when not required for regulatory compliance.

Laminates, in general, are articles comprised of multiple sheets of thin, relative to their length and width, material, with each thin sheet having two oppositely disposed major faces and typically of relatively uniform thickness, which are permanently bonded to one and other across at least one major face of each sheet.

Laminated safety glass is made by bonding two sheets of annealed glass together using a plastic bonding layer comprised of a thin sheet of transparent thermo plastic.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic layer helping to maintain the structural integrity of the glass. A vehicle with a broken windshield can still be operated. The plastic layer 4 also helps to prevent penetration by objects striking the laminate from the exterior and in the event of a crash occupant retention is improved. These are major safety features and the reason why laminated glazing is required for all windshields.

Another advantage of laminated glazing is that various performance films, performance interlayers and coatings may be incorporated into the laminate.

A wide variety of films are available that can be incorporated into a laminate. The uses for these films include but are not limited to: solar control, variable light transmission, increased stiffness, increased structural integrity, improved penetration resistance, improved occupant retention, providing a barrier, tint, providing a sunshade, color correction, and as a substrate for functional and aesthetic graphics. The term “film” shall include these as well as other products that may be developed or which are currently available which enhance the performance, function, aesthetics or cost of a laminated glazing. Most films do not have adhesive properties. To incorporate into a laminate, sheets of plastic interlayer are needed on each side of the film to bond the film to the other layers of the laminate as illustrated in FIG. 1B.

Automotive glazing often makes use of heat absorbing glass compositions to reduce the solar load on the vehicle. While a heat absorbing window can be very effective the glass will heat up and transfer energy to the passenger compartment through convective transfer and radiation. A more efficient method is to reflect the heat back to the atmosphere allowing the glass to stay cooler. This is done using various infrared reflecting films and coatings. Infrared coatings and films are generally too soft to be mounted or applied to a glass surface exposed to the elements. Instead, they must be fabricated as one of the internal layers of a laminated product to prevent damage and degradation of the film or coating.

Interlayers are available with enhanced capabilities beyond bonding the glass layers together. The invention may include interlayers designed to dampen sound. Such interlayers are comprised whole or in part of a layer of plastic that is softer and more flexible than that normally used. The interlayer may also be of a type which has solar attenuating properties.

There are various processes used to bend the glass layers comprising a laminate.

Gravity bending is a process in which the glass is heated to its softening temperature at which the hot soft glass is allowed to sag under the influence of gravity, to its final shape. The typical process uses a female mold that supports the glass near its periphery. The outer glass layer is placed on the mold first with the inner glass layer stack on top of it. The advantage to this process is that no contact is made with the surface of the glass during heating and forming which lessens the probability of optical defects occurring. The main drawback is that dimensional control is not a precise as with some other bending methods. The two of more flat glass layers are both stacked onto the same mold and bent as a pair. This guarantees a good match between the two surfaces which is a required for good optics and durability.

Gravity bending was used almost exclusively for many years to bend mass series production windshields due to the low cost of the initial tooling and high throughput of the process.

In response to the industry need for better surface control, the industry has been moving toward full and partial surface pressed laminates. In some processes, a full or partial surface press is used in conjunction with a gravity bending process. The glass is at least partially bent using a traditional gravity bending process and then, in the final stage, the press is used to give the glass its final shape. Often times air pressure and vacuum are used to aid compliance to the shape of the press. This process has the advantage in that it can be adapted to an existing gravity bending process and to existing gravity bending tooling. The layers of the laminate are bent in sets at the same time.

For even better surface control, singlet pressing may be used. This process is very similar to the process used to produce tempered parts. The inner and outer glass layers are bent separately. Each glass ply runs through a furnace on roller and is then mated with a full surface press. The glass is transferred from the press to a quench where the glass is rapidly cooled. Due to the thickness of automotive laminate glass, the glass is strengthened but does not achieve a full or high level of temper.

The main drawback to this process is that the throughput is lower than a comparable gravity bending line as the glass layers must be separately bent versus the simultaneous bending of each set with gravity bending.

Due to the need for very uniform, through the thickness, heating of the glass to form the feature lines, doublet gravity bending is not suitable for bending glass with feature lines. The typical process used is a modified singlet pressing process. Each glass layer is bent separately.

The standard interlayer lamination process requires that the gap between the adjacent glass surfaces be very uniform. The thickness of the interlayer is typically less than 1 mm. While the interlayer is a soft plastic, the viscosity is very high. Very little flow can occur. Rather, the glass will tend to deflect giving rise to areas of higher than desired compression and tension. This can lead to premature breakage, trapped air and delamination.

A typical singlet pressed windshield is comprised of identically shaped inner and outer glass layers produced on the same tooling. With radii in the 2-8 meters range, the surface mismatch between the two layers is not critical as the variation on the gap between the layers is on the order of microns. However, if we have a radii of 12 mm on the outside surface of the outer glass layer, a glass thickness of 2 mm and an interlayer of 1 mm, the radius of the offset curve of the inner glass layer would need to be 9 mm for a perfect match. Identically shaped low radii shapes will not nest, as illustrated in the dashed circle of FIGS. 2A and 3A. Therefore, it is necessary to bend the two glass layers to different shapes as shown in FIGS. 2B and 3B. Even with this approach, normal process variation can result in rejects as the variation can be a significant percent of the radii. The tooling and production cost are also higher.

It would be desirable to produce laminates with these small radii feature lines that did not have these limitations.

### BRIEF SUMMARY OF THE INVENTION

Rather than bending multiple layers with small radii feature lines that can be nested and subsequently laminated using standard plastic automotive interlayers, the invention makes use of a two part method for laminating, a dry lamination process and a wet lamination process, which requires only that the feature lines be present in the outer glass layer.

The outer glass layer 201 is bent by the various means available to the desired shape containing feature lines. An inner glass layer 202 is also bent to match the large radii overall shape of the outer glass layer but without the feature lines 30.

The inner glass layer 202 and a middle layer 203 are then assembled such that a sheet of plastic bonding interlayer 4 is positioned between the two major adjacent faces of the inner and middle layers. The assembled glass and plastic layers are then processed using a typical “dry” automotive lamination process. The middle layer 203 can either be an intermediate glass or a plastic layer made of PET, PC, PMMA or similar. The middle layer 203, if a plastic layer, can be used as middle layer or as sacrificial plastic to be removed after lamination. The process is described as dry in that no liquids are used as a part of the laminate in the process.

For the next step, the “wet” lamination process is used to bond the assembled “dry” laminate to the outer glass layer 201 with feature lines 30. As mentioned, it would not be possible to laminate the two opposite adjacent faces of the outer glass layer and either the middle layer 203 or the inner glass layer 202 using a sheet of plastic bonding interlayer 4. In addition to the surface mismatch, bending the middle layer and/or inner layer to the shape of the large radii of the outer layer minus the feature lines will leave large gaps impossible to fill between the outer layer and either the middle layer or the inner layer.

Laminating resin 14 is an optically transparent organic material and formulated to withstand the normal glazing environment for the life of the product.

In a typical “wet” process, the assembly comprising the laminated inner layer 202 and plastic bonding interlayer 4 (and the middle layer 203 if it was not removed after “dry” lamination) is assembled with the outer 201 placed in position. Spacers are used to maintain the desired gap between layers. In some embodiments, a dam is applied to the periphery of the glazing acting as a spacer. This serves the dual purpose of keeping the resin inside the laminate and preventing air and/or humidity from entering the laminate. Various means may be used to evacuate the air and to introduce the laminating resin into the gap formed between the outer glass layer with feature lines and the previous assembly. After filling, the resin is cured causing it to solidify. Various means are employed to cure the resin depending upon the formulation. They include but are not limited to UV, catalytic, heat and evaporation.

While the normal sequence of the method is to perform the dry lamination step followed by the wet lamination step, the order can be reversed in cases in which the middle layer is part of the final laminated glazing provided that the laminating resin is compatible with heat, pressure and other parameters of the dry lamination process.

### Advantages:

Only need to have feature lines in outer glass layer.
   Lower cost
   Higher yields
   Higher throughput
Same surface control specification as an ordinary laminate without feature lines.

### BRIEF DESCRIPTION OF THE SEVERAL VIEWS OF THE DRAWINGS

FIG. 1A shows a cross section of a typical laminated automotive glazing.

FIG. 1B shows a cross section of a typical automotive glazing with performance film.

FIG. 1C shows a cross section of a typical tempered monolithic automotive glazing.

FIG. 2A shows a cross section of a laminated glazing with two identical glass layers.

FIG. 2B shows a cross section of a laminated glazing with two different glass layers.

FIG. 2C shows a cross section of a laminated glazing with feature lines in outer layer according to a first embodiment of the invention.

FIG. 3A shows a cross section of a laminated glazing with three identical layers.

FIG. 3B shows a cross section of a laminated glazing with three different layers.

FIG. 3C shows a cross section of a laminated glazing with feature lines in outer layer according to a second embodiment of the invention.

FIG. 4 shows an exploded view of a laminated glazing according to a first embodiment of the invention.

FIG. 5 shows an exploded view of a laminated glazing according to a second embodiment of the invention.

FIG. 6A shows an isometric view of a laminated glazing according to a second embodiment of the invention.

FIG. 6B shows the cross section AA of FIG. 6C.

FIG. 6C shows a closeup of feature line cross section AA.

### REFERENCE NUMERALS OF DRAWINGS

2 Glass

4 Bonding/Adhesive Layer (interlayer)

6 Obscuration/Black Frit

12 Performance Film

14 Laminating resin

18 Coating

30 Feature Line

101 Surface one

102 Surface two

103 Surface three

104 Surface four

105 Surface five

106 Surface Six

201 Outer layer

202 Inner layer

203 Middle layer

### DETAILED DESCRIPTION OF THE INVENTION

The following terminology is used to describe the laminated glazing of the invention.

The term “glass” can be applied to many organic and inorganic materials, include many that are not transparent. For this document we will only be referring to nonorganic transparent glass. From a scientific standpoint, glass is defined as a state of matter comprising a non-crystalline amorphous solid that lacks the ordered molecular structure of true solids. Glasses have the mechanical rigidity of crystals with the random structure of liquids.

Glass is formed by mixing various substances together and then heating to a temperature where they melt and fully dissolve in each other, forming a forming a miscible homogeneous fluid.

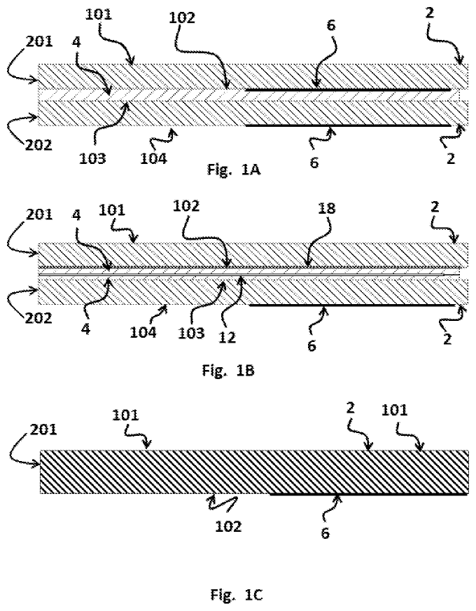

Typical automotive laminated glazing cross sections are illustrated in FIGS. 1A and 1B. A laminate is comprised of at least two layers of glass, the exterior or outer, 201 and interior or inner, 202 that are permanently bonded together by a plastic layer 4 (interlayer).

In a laminate, the glass surface that is on the exterior of the vehicle is referred to as surface one 101 or the number one surface. The opposite face of the exterior glass layer 201 is surface two 102 or the number two surface. The glass 2 surface that is on the interior of the vehicle is referred to as surface four 104 or the number four surface. The opposite face of the interior layer of glass 202 is surface three 103 or the number three surface. Surfaces two 102 and three 103 are bonded together by the plastic layer 4. Additional glass layers may be utilized as is often the case with ballistic resistant glazing in which case they shall be numbered sequentially from the outer layer. In the case of a laminate with three glass layers, there is a middle glass layer 203 having two opposite faces: surface five 105 and surface six 106.

An obscuration 6 may be also applied to the glass. Obscurations are commonly comprised of black enamel frit printed on either the number two 102 or number four surface 104 or on both.

The laminate may have a coating 18 on one or more of the surfaces. The laminate may also comprise a film 12 laminated between at least two plastic layers 4.

FIG. 1C shows a typical tempered automotive glazing cross section. Tempered glazing is typically comprised of a single layer of glass 201 which has been heat strengthened. The glass surface that is on the exterior of the vehicle is referred to as surface one 101 or the number one surface. The opposite face of the exterior glass layer 201 is surface two 102 or the number two surface. The number two surface 102 of a tempered glazing is on the interior of the vehicle. An obscuration 6 may be also applied to the glass. Obscurations are commonly comprised of black enamel frit printed on the number two 102 surface. The glazing may have a coating 18 on the number one 101 and/or number two 102 surface.

A glazing is an article comprised of at least one layer of a transparent material which serves to provide for the transmission of light and/or to provide for viewing of the side opposite the viewer and which is mounted in an opening in a building, vehicle, wall or roof or other framing member or enclosure.

Laminates, in general, are articles comprised of multiple sheets of thin, relative to their length and width, material, with each thin sheet having two oppositely disposed major faces and typically of relatively uniform thickness, which are permanently bonded to one and other across at least one major face of each sheet.

Laminated safety glass is made by bonding at least two sheets (201 & 202) of annealed glass 2 together using a plastic bonding layer comprised of a thin sheet of transparent thermo plastic 4 (interlayer) as shown in FIG. 1.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic layer helping to maintain the structural integrity of the glass. A vehicle with a broken windshield can still be operated. The plastic layer 4 also helps to prevent penetration by objects striking the laminate from the exterior and in the event of a crash occupant retention is improved.

The plastic bonding layer 4 (interlayer) has the primary function of bonding the major faces of adjacent layers to each other. The material selected is typically a clear thermoset plastic.

For automotive use, the most commonly used bonding layer 4 (interlayer) is polyvinyl butyral (PVB). PVB has excellent adhesion to glass and is optically clear once laminated. It is produced by the reaction between polyvinyl alcohol and n-butyraldehyde. PVB is clear and has high adhesion to glass. However, PVB by itself, it is too brittle. Plasticizers must be added to make the material flexible and to give it the ability to dissipate energy over a wide range over the temperature range required for an automobile. Only a small number of plasticizers are used. They are typically linear dicarboxylic esters. Two in common use are di-n-hexyl adipate and tetra-ethylene glycol di-n-heptanoate. A typical automotive PVB interlayer is comprised of 30-40% plasticizer by weight.

In addition to polyvinyl butyl, ionoplast polymers, ethylene vinyl acetate (EVA), cast in place (CIP) liquid resin and thermoplastic polyurethane (TPU) can also be used. Automotive interlayers are made by an extrusion process with has a thickness tolerance and process variation. As a smooth surface tends to stick to the glass, making it difficult to position on the glass and to trap air, to facilitate the handling of the plastic sheet and the removal or air (deairing) from the laminate, the surface of the plastic is normally embossed contributing additional variation to the sheet. Standard thicknesses for automotive PVB interlayer at 0.38 mm and 0.76 mm (15 and 30 mil).

### Description of Embodiments

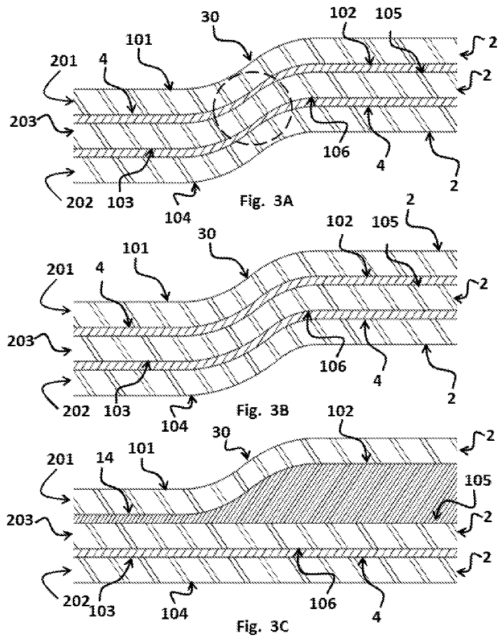

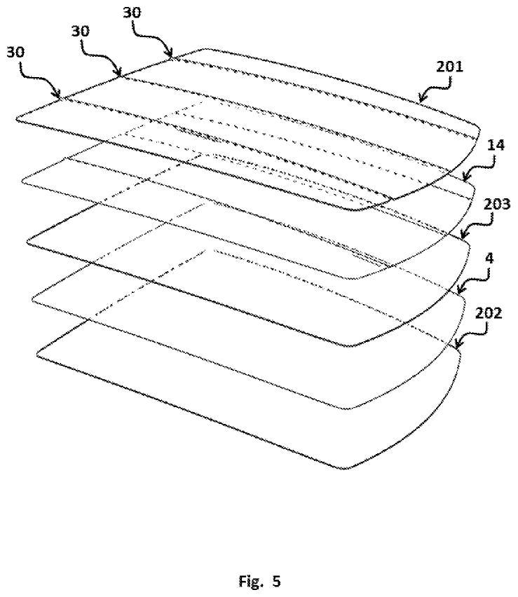

FIGS. 3C, 5, 6A, 6B and 6C show a typical embodiment of a laminated glazing having three glass layers. The glazing illustrated is a roof laminate with three feature lines 30. The approximate dimensions are 1200 mm×950 mm.

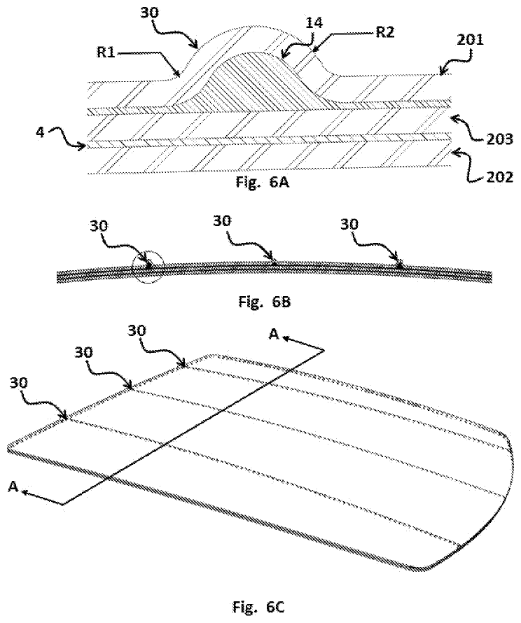

The feature lines are only present in the outer glass layer 201 as illustrated in the cross-sections. The feature lines run the length of the laminate. The radii of the curves, on the outer most surface 101, are R1=6 mm and R2=12 mm as illustrated in FIG. 6A.

The outer layer 201 is first heated and pre-bent to an intermediate stage. Additional localized heat is applied by means of a LASER and then full surface press us used to achieve the final shape with feature lines.

A middle layer 203 and an inner glass layer 202 are heated and bent to shape separately.

A black obscuration is screen printed on the inner surface 102 of the outer glass layer 201 and on the inner surface 104 of the inner glass layer 202.

The outer glass layer 201 is comprised of a clear, 2.1 mm annealed soda-lime glass. The middle layer 203 is also comprised of a clear 2.1 mm annealed soda-lime glass. The middle layer also has a solar reflecting vacuum sputtered coating on the number six surface 106. The inner glass layer 202 is comprised of a 2.1 mm thick dark solar grey soda-lime glass. A dark grey 0.76 mm PVB interlayer 4 is used to laminate the middle layer 203 to the inner layer 202. The total visible light transmission of the compete laminate is less than 5%.

The gap between the outer 201 and middle glass layer 203 is laminated by means of a wet lamination process using a UV cured laminating resin 14. The middle layer 203 and inner layer 202 are processed using a dry lamination process in which a vacuum is drawn to evacuate any air between the layers, the assembly is heated and then the assembly is placed in an autoclave where heat and pressure are used to permanently bond the two glass layers. The laminated assembly comprising the middle layer 203 and inner glass layer 202 is then laminated to the outer layer 201 with feature lines using a wet process. In this process, spacers (not shown) are installed on the surface five 105 of the dry laminated assembly. The spacers are hidden by the black obscuration and will become a permanent part of the laminate. Then the outer layer with feature lines 201 is matched to the assembly. A polymeric gasket can be applied to the glass providing a seal to prevent the ingress of air and to prevent the liquid laminating resin from escaping during the fill process. A vacuum is drawn as the laminating resin 14 is pumped into the gap between the outer layer 201 and the laminated assembly comprising the plastic bonding interlayer 4, the middle layer 203 and the inner layer 202. The fill is measured so as to prevent under or over filling. A vacuum is maintained for a predetermined period to guarantee the evacuation of all air. The laminating resin 14 is then cured by exposure to high intensity UV light. Other known methods of curing may include a secondary thermal cure, or just thermal cure. The gasket is removed (if any), the edges are trimmed, and the laminate is inspected completing the process.

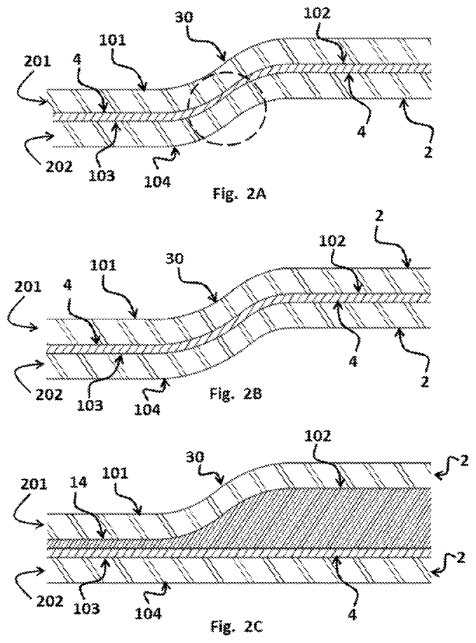

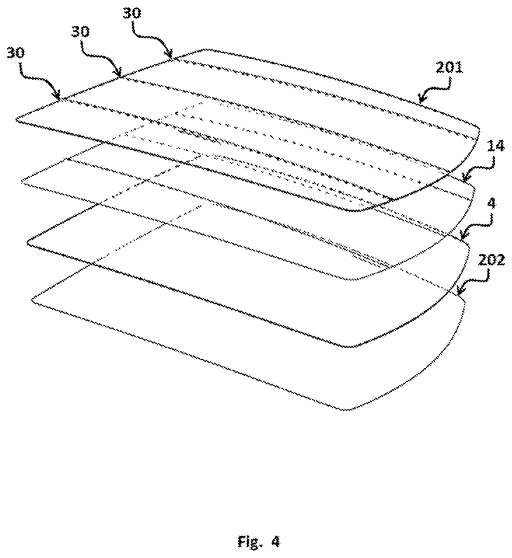

FIGS. 2C and 4 show a typical embodiment of a laminated glazing having two glass layers. This embodiment is the same as previous embodiment with the exception that the middle layer 203 is a PET sacrificial plastic layer which is removed after the completion of the dry lamination process. The current laminated assembly comprising at least one plastic bonding interlayer 4 and the inner glass layer 202 is then laminated to the outer layer 201 with feature lines using a wet process (laminating resin). Vacuum may be used to prevent air between the laminated assembly, before resin pumping, pumping in a vacuum environment, or after resin is being pumped to remove any formed bubble.

Additional embodiments are the same as previous ones with the exception that the inner layer 202 is a plastic layer selected from the group consisting of PC, PMMA and other similar.

In several embodiments, the laminating resin is a curable Optically Clear Resin (OCR), also known as Liquid Optically Clear Adhesive (LOCA). The laminating resin can be cured by UV radiation, thermal exposition, moisture cure, catalytic reaction, crosslinking, among others. In all the embodiments, the chemical nature of said adhesives can be acrylic, silicone, epoxy, urethane, sulfide based, or combinations thereof.

1. An automotive laminated glazing with small radii features lines comprising:
an outer glass layer with small radii feature lines having interior and exterior surfaces;
a cured laminating resin; and
a first stack of components comprising
an inner glass layer having interior and exterior surfaces; and
at least one plastic bonding layer facing the interior surface of the inner glass layer;
wherein the first stack of components is disposed on and bonded to the interior surface of the outer glass layer by said cured laminating resin, such that the interior surface of the outer glass layer is facing said at least plastic bonding interlayer such that the at least plastic bonding interlayer is located between the inner and outer glass layers.

2. The automotive laminated glazing according to claim 1, wherein the first stack of components further comprising: a middle layer having interior and exterior surfaces; wherein the at least one plastic bonding layer is located between interior surfaces of inner glass layer and middle layer; and wherein the interior surface of the outer glass layer is facing the exterior surface of the middle glass layer.

3. The automotive laminated glazing according to claim 2, wherein the middle layer is made of glass, PET, PC or PMMA.

4. The automotive laminated glazing according to any one of the preceding claims further comprising a solar reflecting coating.

5. The automotive laminated glazing according to any one of the preceding claims, wherein the laminating resin is a liquid optically clear adhesive.

6. The automotive laminated glazing according to any one of the preceding claims, wherein the laminating resin is cured by one of the following: UV radiation, thermal exposition, moisture cure, catalytic reaction, or crosslinking.

7. The laminated glazing according to any one of the preceding claims further comprising spacers between the middle layer and the outer glass layer.

8. The laminated glazing according to any one of the preceding claims further comprising a dam applied to the periphery of the laminated glazing.

9. The laminated glazing according to claim 8, wherein the dam is a spacer.

10. A method for producing an automotive laminated glazing with small radii feature lines comprising the steps of:
providing
an outer glass layer with small radii feature lines,
an inner glass layer,
a middle layer,
at least one plastic bonding interlayer,
a laminating resin;
assembling said inner glass layer and said middle layer such that at least one plastic bonding interlayer is located between the adjacent major faces of said layers;
processing assembled inner glass layer, middle layer and said at least one plastic bonding interlayer through a standard dry automotive laminating process;
assembling outer glass layer with the laminated assembly of previous step; and
performing a wet lamination process comprising the steps of:
filling the gap between said assembly and outer glass layer with the laminating resin, and
curing said laminating resin.

11. The method for producing an automotive laminated glazing according to claim 10, wherein between the steps of processing assembled layers through a standard dry automotive laminating process and assembling outer glass layer with the laminated assembly of previous step, further comprising the step of removing the middle layer from the assembly.

12. The method for producing an automotive laminated glazing according to any one of the claims 10 to 11, wherein the step of assembling outer glass layer with laminated assembly of previous steps comprises the step of providing spacers between the outer glass layer and the laminated assembly.

13. The method for producing an automotive laminated glazing according to claim 12 further comprising the step of applying a dam to the periphery of the assembly.

14. A method for producing an automotive laminated glazing with small radii feature lines comprising the steps of:
providing
an outer glass layer with small radii feature lines,
an inner glass layer,
at least one middle glass layer,
at least one plastic bonding interlayer,
a laminating resin;
assembling outer glass layer with middle layer;
performing wet lamination process comprising the steps of:
filling the gap between said middle layer and outer glass layer with laminating resin,
curing said resin;
assembling said inner glass layer with the laminated assembly of previous step such that at least one plastic bonding interlayer layer is located between the adjacent major faces of inner glass layer and middle layer; and
processing assembled outer layer and middle layer with the inner glass layers and said at least one plastic bonding interlayer through a standard automotive dry laminating process.

15. The method for producing an automotive laminated glazing according to claim 14, wherein the step of assembling outer glass layer with middle glass layer comprises the step of providing spacers between the middle glass layer and the outer glass layer.

16. The method for producing an automotive laminated glazing according to any one of the claims 14 to 15 further comprising the step of applying a dam to the periphery of the assembly.
